(19) United States
(12) Patent Application Publication
(10) Pub. No.: US 2013/0027167 A1
(43) Pub. Date: Jan. 31, 2013

(54) CIRCUIT BOARD AND METHOD FOR MOUNTING AIR CORE COIL

(71) Applicant: Eiichi Sano, Kanagawa (JP)

(72) Inventor: Eiichi Sano, Kanagawa (JP)

(73) Assignee: SONY CORPORATION, Tokyo (JP)

(21) Appl. No.: 13/552,021

(22) Filed: Jul. 18, 2012

(30) Foreign Application Priority Data
Jul. 26, 2011 (JP) 2011-163244

(51) Int. Cl. H01F 27/29; H01R 43/00

(52) U.S. Cl. 336/192; 29/825

(57) ABSTRACT

Provided is a circuit board including an air core coil including a winding portion having a conductive wire wound in a helical shape, a first lead portion extending from an end of the winding portion, and a second lead portion extending from another end of the winding portion, wherein the first lead portion and the second lead portion extend in different directions from each other on a substantially same plane, and a coil mounting portion including an opening to accommodate the winding portion, a first conductive part provided on a periphery of the opening and contacting the first lead portion, and a second conductive part provided on the periphery of the opening and contacting the second lead portion.

### BACKGROUND

The present disclosure relates to a circuit board and a method for mounting an air core coil, and particularly to a technique for mounting an air core coil on a circuit board which is mounted on a low-profile electronic device.

Some circuit boards mounted on electronic devices are provided with air core coils thereon. The air core coil is formed of, for example, a conductive wire wound in a helical shape, and is soldered on the circuit board by the use of a mounter. For example, JP H08-172299A describes a technique for mounting an air core coil on the surface of a circuit board utilizing a special mounter dedicated for air core coils.

### SUMMARY

As described in JP H08-172299A, the air core coil mounted on the circuit board protrudes relatively high from the circuit board at its winding portion. FIG. 11 is a side view of an air core coil 2 mounted on a circuit board 3. The air core coil 2 has a winding portion 2a of a conductive wire wound a plurality of times in a helical shape, a first lead portion 2b extending from a first end of the winding portion 2a, and a second lead portion 2c extending from a second end of the winding portion 2a. The first lead portion 2b and the second lead portion 2c extend toward the outer side of the winding portion 2a in the same direction, and are substantially parallel to each other.

As shown in FIG. 11, the air core coil 2 is mounted on the circuit board 3 by inserting the first lead portion 2b and the second lead portion 2c respectively into an opening 3a and an opening 3b provided on the circuit board 3. This mounting method causes the winding portion 2a of the air core coil 2 to be placed on the circuit board 3. This arrangement prevents a housing to accommodate the circuit board of the electronic device therein from being lower than the height corresponding to the outer diameter of the winding portion 2a.

A smaller diameter of the winding portion 2a leads to a lower height of the winding portion of the air core coil 2 protruding from the circuit board 3. However, in some applications of the air core coil 2, the diameter of the winding portion 2a may not be reduced. Thus, the air core coil 2 has been a main factor preventing an electronic device having a circuit board mounted thereon from being thinner and miniaturized.

In light of the foregoing, it is desirable to reduce the height of an air core coil mounted on a circuit board.

According to an embodiment of the present disclosure, a circuit board including an air core coil and a coil mounting portion is provided, and the configuration and function of each component are now described. The air core coil has a winding portion having a conductive wire wound in a helical shape, a first lead portion extending from an end of the winding portion, and a second lead portion extending from another end of the winding portion. The first lead portion and the second lead portion extend in different directions from each other on a substantially same plane. The coil mounting portion includes an opening to accommodate the winding portion, a first conductive part provided on a periphery of the opening and contacting the first lead portion, and a second conductive part provided on the periphery of the opening and contacting the second lead portion.

Furthermore, according to an embodiment of the present disclosure, a method for mounting an air core coil involves the following steps. The winding portion of the air core coil is accommodated in the opening provided at the coil mounting portion. The air core coil has the first lead portion extending from an end of the winding portion, and the second lead portion extending from another end of the winding portion. The first lead portion and the second lead portion extend in different directions from each other on a substantially same plane. The coil mounting portion includes the opening to accommodate the winding portion, the first conductive part provided on a periphery of the opening and contacting the first lead portion, and the second conductive part provided on the periphery of the opening and contacting the second lead portion. The first lead portion and the second lead portion of the air core coil are then electrically connected to the first conductive part and the second conductive part of the coil mounting portion, respectively.

The configuration and mounting method allow the first lead portion and the second lead portion to be placed on the coil mounting portion while the air core coil is accommodated in the opening. The air core coil embedded in the opening allows the air core coil to protrude from the circuit board by a greatly reduced height.

The circuit board and the method for mounting the air core coil according to an embodiment of the present disclosure allow the mounting height of the air core coil on the circuit board to be reduced.

### BRIEF DESCRIPTION OF THE DRAWINGS

FIG. 1 is a perspective view illustrating an exemplary configuration of an air core coil mounted on a circuit board according to an embodiment of the present disclosure;

FIG. 2 is a perspective view illustrating an exemplary condition of the air core coil mounted on the circuit board according to an embodiment of the present disclosure;

FIG. 3 is a side view illustrating an exemplary condition of the air core coil mounted on the circuit board according to an embodiment of the present disclosure, and being vacuum-adsorbed by a suction nozzle of an automatic mounter;

FIG. 4 is a top view illustrating a modification 1 of the air core coil mounted on the circuit board according to an embodiment of the present disclosure;

FIG. 5 is a top view illustrating a modification 2 of the air core coil mounted on the circuit board according to an embodiment of the present disclosure;

FIG. 6 is a block diagram showing an exemplary internal configuration of a tuner section to which the circuit board according to an embodiment of the present disclosure is mounted;

FIG. 7 is a block diagram showing an exemplary internal configuration of a high-pass filter (HPF) within the tuner section to which the circuit board according to an embodiment of the present disclosure is mounted;

FIG. 8A is a top view showing exemplary dimensions of the air core coil mounted on the circuit board according to an embodiment of the present disclosure;

FIG. 8B is a side view showing exemplary dimensions of the air core coil mounted on the circuit board according to an embodiment of the present disclosure;

FIG. 9 is a top view illustrating an exemplary condition of the air core coil mounted on the circuit board according to an embodiment of the present disclosure;

FIG. 10 is a cross-sectional view illustrating an exemplary condition of the circuit board according to an embodiment of the present disclosure mounted to the tuner section; and

FIG. 11 is a cross-sectional view illustrating an exemplary condition of the air core coil mounted on a circuit board in the related art.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In accordance with an embodiment of the present disclosure, an exemplary circuit board having an air core coil mounted thereon, and a method for mounting an air core coil are now described in the following order referring to the drawings: 1. Exemplary Configuration of Air Core Coil, 2. Exemplary Mounting of Air Core Coil on Circuit Board, 3. Modifications of Air Core Coil, 4. Exemplary Configuration of Air Core Coil Applied to Tuner Section of Television Receiver.

### <1. Exemplary Configuration of Air Core Coil>

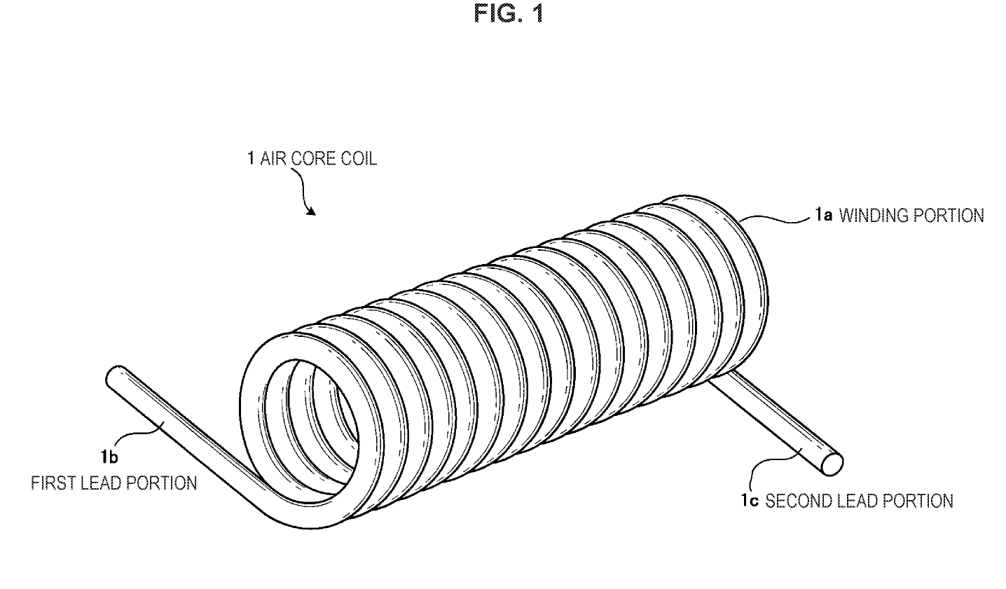

The air core coil mounted on the circuit board according to an embodiment of the present disclosure is described referring to FIG. 1. FIG. 1 is a perspective view illustrating an exemplary configuration of an air core coil 1. The air core coil 1 has a winding portion 1a having a conductive wire wound in a helical shape, a first lead portion 1b extending linearly from a first end of the winding portion 1a, and a second lead portion 1c extending linearly from a second end of the winding portion 1a. The first lead portion 1b and the second lead portion 1c extend in different directions from each other on substantially the same plane, namely, extending in opposite directions at an approximately 180 degree angle to each other.

### <2. Exemplary Mounting of Air Core Coil on Circuit Board>

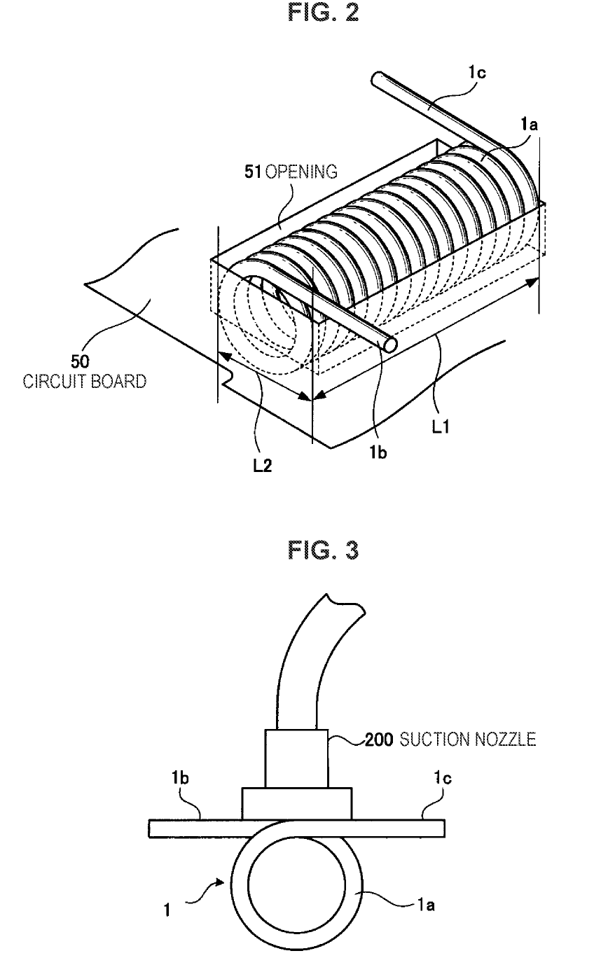

FIG. 2 is a view illustrating the air core coil 1 accommodated in an opening 51 provided on a circuit board 50. The long sides of the opening 51 are slightly longer than the length L1 of the winding wire in the winding direction of the winding portion 1a of the air core coil 1. The short sides of the opening 51 are set such that the gaps between the edges of the winding portion 1a and the sides of the opening 51 are 0.15 mm. More specifically, the short sides of the opening 51 are equal to the outer diameter L2 of the winding portion 1a+0.3 mm. The short sides of the opening 51 are longer than the outer diameter of the winding portion 1a and shorter than the total length of the outer diameter of the winding portion 1a, the first lead portion 1b, and the second lead portion 1c. Thus, the short sides of the opening 51 are long enough to stably support the air core coil 1 on the circuit board 50 by the first lead portion 1b and the second lead portion 1c.

The opening 51 designed in such a size and the air core coil 1 assuming the shape as shown in FIG. 1 allow the first lead portion 1b and the second lead portion 1c of the air core coil 1 to be placed on the circuit board 50 while the air core coil 1 is accommodated in the opening 51. This configuration allows the winding portion 1a of the air core coil 1 to be embedded in the opening 51, which allows the air core coil 1 to protrude from the circuit board 50 along the thickness direction of the circuit board 50 by a greatly reduced height. The height of the air core coil 1 protruding from the circuit board 50 is equal to the length obtained by subtracting the thickness of the circuit board from the outer diameter of the winding portion 1a.

Furthermore, the first lead portion 1b and the second lead portion 1c of the air core coil 1 are placed on the circuit board 50 while the winding portion 1a of the air core coil 1 is accommodated in the opening 51. Therefore, the air core coil 1 may be held on the circuit board 50 without being soldered. Additionally, the opening 51 is large enough to accommodate the winding portion 1a of the air core coil 1. Accommodating the winding portion 1a of the air core coil 1 in the opening 51 defines the position of the air core coil 1 in the horizontal direction and in the vertical direction with respect to the opening 51.

In the configuration in the related art shown in FIG. 11, the diameters of an opening 3a and an opening 3b into which a first lead portion 2b and a second lead portion 2c are inserted respectively are excessively small, which involves highly precise positioning upon mounting of the air core coil 2 on the circuit board 3. As a countermeasure against this problem, the configuration according to the embodiment described above is provided to avoid such a complicated positioning. Accordingly, the air core coil 1 may be accommodated into the opening 51 by a general automatic mounter, not by a special mounter dedicated for air core coils or by a human being.

FIG. 3 is a side view of the air core coil 1 adsorbed by a suction nozzle 200 of an automatic mounter. The automatic mounter (not shown) vacuum-adsorbs the surface of the air core coil 1 from which the first lead portion 1b and the second lead portion 1c extend by the suction nozzle 200. The automatic mounter then transfers the air core coil 1 to the top of the opening 51 of the circuit board 50 shown in FIG. 2 and releases vacuum-adsorption. This operation causes the winding portion 1a to be accommodated in the opening 51 of the air core coil 1, and the first lead portion 1b and the second lead portion 1c to rest on the circuit board 50.

In the exemplary condition shown in FIG. 3, the first lead portion 1b and the second lead portion 1c are exactly parallel with the adsorption face of the suction nozzle 200. However, they may not be completely parallel, because releasing vacuum-adsorption causes one of the first lead portion 1b and the second lead portion 1c to contact the circuit board 50, and thereby the other lead portion then contacts the circuit board 50, and thereby the winding portion 1a is accommodated in the opening 51.

### <3. Modifications of Air Core Coil>

In the embodiment described above, the first lead portion 1b and the second lead portion 1c extend linearly from the winding portion 1a. However, they are not limited to this configuration. As shown in FIG. 4, the ends of a first lead portion 1b′ and a second lead portion 1c′ may be bent at approximately 90 degrees so as to provide a pair of straight portions which are substantially parallel with the winding direction of a winding portion 1a′. Such a configuration causes the first lead portion 1b′ and the second lead portion 1c′ to contact the circuit board 50, and thereby L-shaped (two-leg) lead portions 1b′ and 1c′ contact the circuit board 50, which allows the air core coil 1 to be mounted on the circuit board 50 in more stable condition.

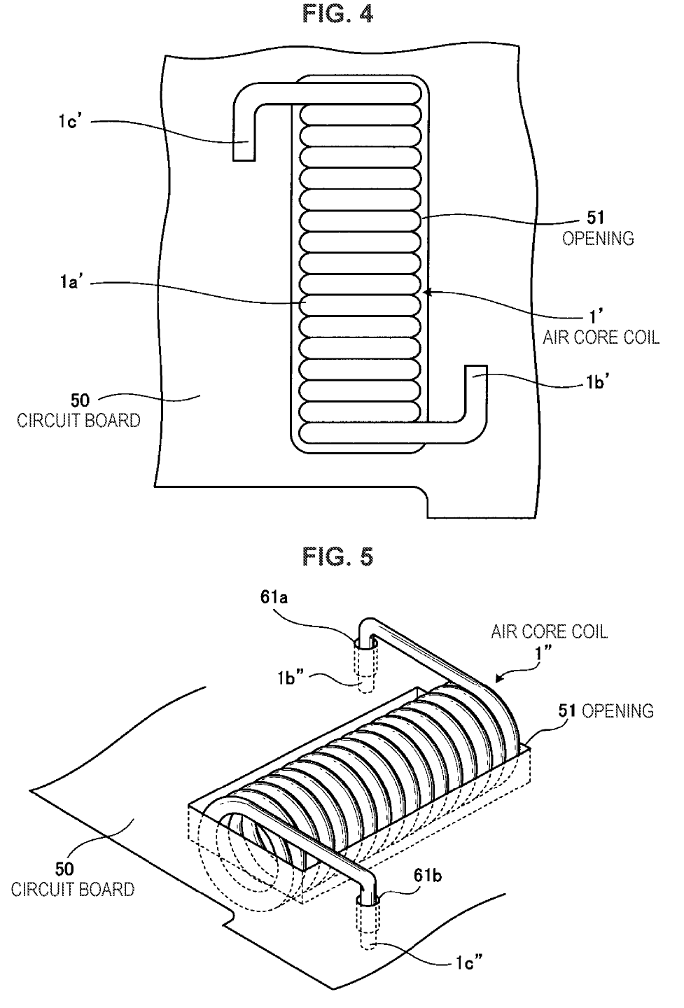

Alternatively, as shown in FIG. 5, the ends of a first lead portion 1b″ and a second lead portion 1c″ of an air core coil 1″ may be bent in the direction perpendicular to the circuit board 50. In this case, the circuit board 50 is preferably provided with an opening 61a to receive the first lead portion 1b″ and an opening 61b to receive the second lead portion 1c″. The first lead portion 1b″ and the second lead portion 1c″ are then inserted into these openings, and thereby a winding portion 1a″ is accommodated in the opening 51.

In the embodiment described above, the opening 51 to accommodate the air core coil 1 is a hole; however, it is not limited to this shape. Alternatively, the opening 51 may be, for example, a notch provided at the side of the circuit board 50.

### <4. Exemplary Configuration of Air Core Coil Applied to Tuner Section of Television Receiver>

An exemplary air core coil 1 used to prevent a device from being destroyed by a lightning-induced surge is now described. While coils as a countermeasure against a lightning-induced surge are employed in various electronic devices, the exemplary air core coil 1 described herein is applied to a television receiver.

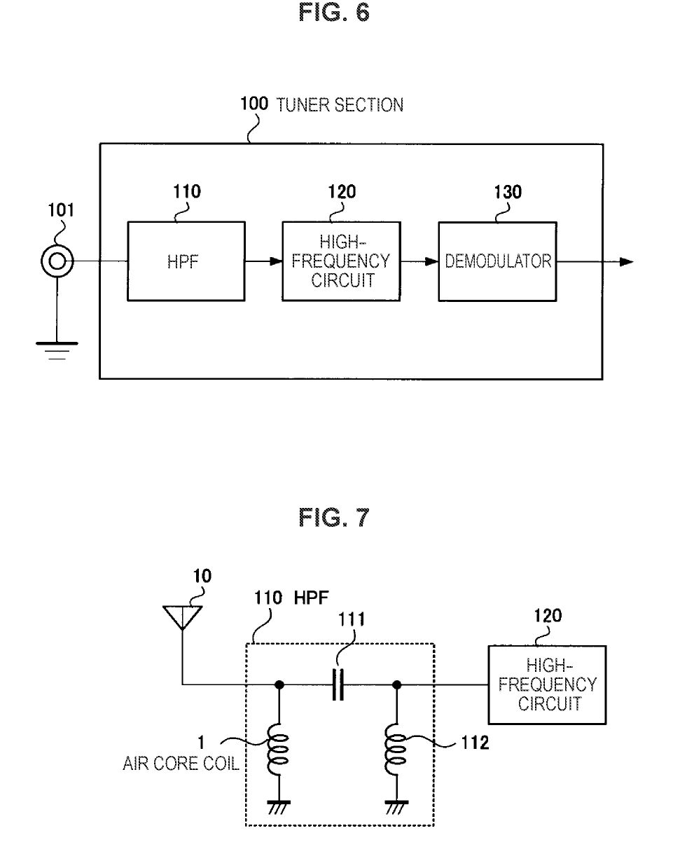

FIG. 6 is a block diagram showing an exemplary configuration of a tuner section 100 of the television receiver. The tuner section 100 includes a high-pass filter 110 (hereinafter referred to as “HPF 110”), a high-frequency circuit 120, and a demodulator 130. The HPF 110 removes unwanted signals having out-of-band frequencies from RF (radio frequency) signals that have been input from an antenna input terminal 101, and outputs the resulting signals to the high-frequency circuit 120. A detailed explanation regarding the configuration of HPF 110 will be described below referring to the next drawing, FIG. 7.

The high-frequency circuit 120 including an AGC (automatic gain control), a local oscillator, and a frequency converter (not shown) amplifies the resulting signals from which unwanted frequencies have been removed by the HPF 110, selects a signal having the same frequency as a receiving channel, and outputs the selected signal. The demodulator 130 demodulates the signal output from the high-frequency circuit 120 by the use of a modulation scheme which is the same as that for signals output from a transmitter (not shown).

FIG. 7 is a block diagram showing an exemplary configuration of the HPF 110. An antenna 10 is connected through a capacitor 111 to the high-frequency circuit 120 (refer to FIG. 6). The capacitor 111 has a first end to which a signal is input, and the first end is grounded through the air core coil 1 as an inductor. The second end is grounded through a different inductor 112. The HPF including the air core coil 1 as an inductor, the capacitor 111, and the inductor 112 removes signals having specific frequencies.

A cut-off frequency of the HPF 110 is preferably 90 MHz or less to receive, for example, ground-wave digital television broadcasting in Japan at present, because the center frequency of the lowest frequency used as the channel frequency of the ground-wave television broadcasting at the present is 93 MHz. In order to obtain the cut-off frequency of the HPF 110 of 90 MHz or less, preferably, inductance between the air core coil 1 and the inductor 112 is empirically 160 nH or greater to provide a sufficiently high impedance.

The air core coil 1 as the inductor of the HPF 110 has a first end directly connected to the input terminal of the antenna 10 and a second end grounded. The air core coil also serves to avoid destruction by an induced lightning. A voltage of a lightning-induced surge is about ±9 kV, which is excessively high. Applying such a high voltage at ±9 kV melts a pattern inductor formed on the circuit board or a chip inductor of a chip component having a low withstand voltage. Thus, the air core coil is preferably used to avoid destruction by an induced lightning. However, the diameter of the conductive wire of the air core coil is preferably thick to some extent so as to provide resistance against the lightning-induced surge.

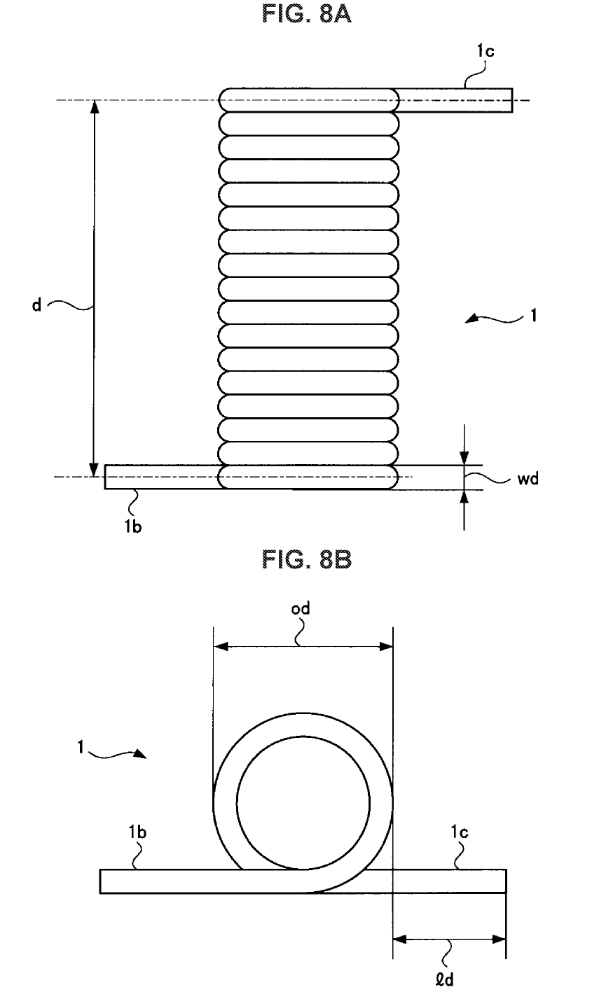

FIGS. 8A and 8B are schematic views of the air core coil 1 which meets all requirements described above. FIG. 8A is a top view, and FIG. 8B is a side view of the air core coil 1. As shown in FIG. 8A, the wire diameter wd of the conductive wire of the air core coil 1 is 0.35 mm and a winding number is 17 times. With this configuration, the dimension d between the center lines of the first lead portion 1b and the second lead portion 1c is 7.1 mm. The winding number of the air core coil 1 is determined so as to avoid warping of the air core coil 1 during vacuum adsorption by the suction nozzle 200 (refer to FIG. 3), and may be set to any number depending on the size of the suction nozzle 200 and the intensity of vacuum adsorption.

If the winding number of the air core coil 1 is set to 17 times and the dimension d of the winding wire along the winding direction is set to 7.1 mm, the outer diameter od of the air core coil 1 is preferably set to approximately 3 mm to provide inductance of 160 nH or greater as mentioned above. According to the present embodiment, the outer diameter od of the air core coil 1 is set to 2.7 mm as shown in FIG. 8B. The first lead portion 1b and the second lead portion 1c are exposed bare wires without coating and solder-plated. The length ld of the first lead portion 1b and the second lead portion 1c is set to 1.7 mm. The dimensions shown in FIGS. 8A and 8B (designed dimensions of the air core coil 1) are merely one example and not limiting ones.

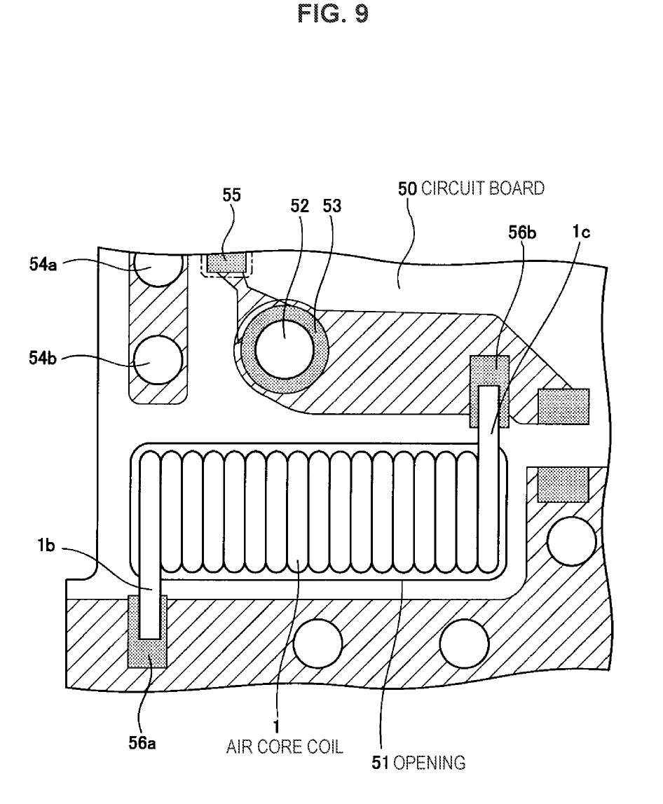

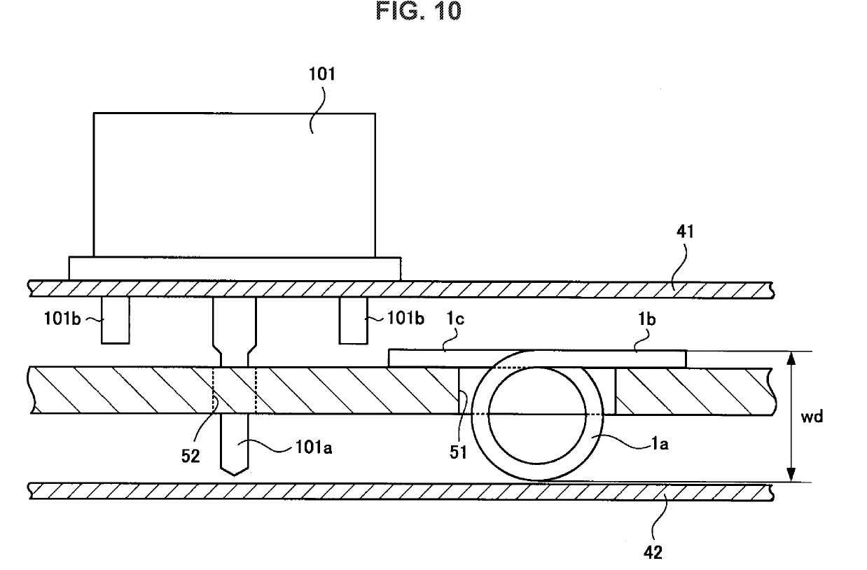

FIG. 9 is a top view of the air core coil 1 having the configuration described above, and the air core coil 1 is embedded in the opening 51 of the circuit board 50 to be a coil mounting portion. FIG. 9 partially shows the circuit board 50, namely only the opening 51 to accommodate the air core coil 1 and its peripheral area. In FIG. 9, the circuit board 50 configuring a printed circuit board has diagonally shaded areas covered by copper foils and dot-shaded conductive parts without resists or insulating coating.

At the upper portion of the circuit board 50 shown in FIG. 9, a through hole 52 to receive a central conductive connector of a connecting component of the antenna input terminal 101 (refer to FIG. 6) is provided. In its peripheral area, a conductive part 53 is formed. At the left side of the through hole 52, a through hole 54a and a through hole 54b are provided for ground potential connections. At the right side of the through hole 54a, a conductive part 55 for a capacitor 111 of the HPF 110 (refer to FIG. 7) is formed.

At the side of the through hole 52 to which the connecting component of the antenna input terminal 101 is connected, the opening 51 to accommodate the air core coil 1 is provided. At the lower left side of the opening 51, a conductive part 56a as a first conductive part is formed, and at the diagonal upper right side of the opening 51, a conductive part 56b as a second conductive part is formed. The winding portion 1a of the air core coil 1 accommodated in the opening 51 causes the first lead portion 1b and the second lead portion 1c of the air core coil 1 to contact the conductive parts 56a and 56b, respectively. The first lead portion 1b and the second lead portion 1c are electrically connected to the conductive part 56a and the conductive part 56b respectively by soldering.

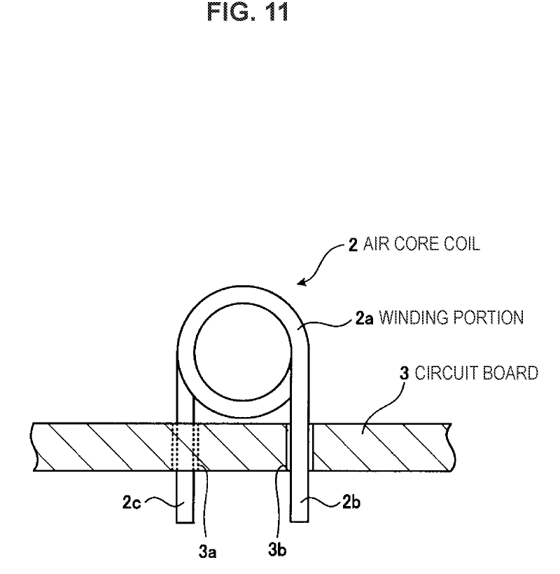

FIG. 10 is a cross-sectional view illustrating an exemplary configuration of the tuner section 100 provided with the air core coil 1 and the circuit board 50. A cover 41 and a cover 42 are attached to the upper portion and the lower portion of the circuit board 50, respectively. The upper cover 41 is provided with the antenna input terminal 101 thereon. A central conductive connector 101a extending from the rear side of the connecting component of the antenna input terminal 101 is inserted into the through hole 52 formed through the circuit board 50. Grounding connectors 101b extending from the rear side of the connecting component of the antenna input terminal 101 are directly connected to the cover 41.

At the immediate right side of the through hole 52, the opening 51 is provided. The opening 51 accommodates the winding portion 1a of the air core coil 1. The winding portion 1a of the air core coil 1 accommodated in the opening 51 causes the first lead portion 1b and the second lead portion 1c of the air core coil 1 to contact the conductive parts 56a and 56b of the circuit board 50 (refer to FIG. 9) respectively.

The air core coil 1 mounted to the circuit board 50 in such a manner allows the air core coil 1 to protrude along the thickness direction of the circuit board 50 by the height which is equal to the height obtained by subtracting the thickness of the circuit board 50 from the outer diameter od of the air core coil 1. Accordingly, the upper cover 41 and the lower cover 42 are placed closer to the circuit board 50, which may result in a thinner tuner section 100. The thickness of the television receiver provided with the thinner tuner section 100 may also be reduced by the reduced thickness of the tuner section 100.

Additionally, the air core coil 1 having the first lead portion 1b and the second lead portion 1c extending in different directions from each other on substantially the same plane and the opening 51 to accommodate the air core coil 1 and mounted on the circuit board 50 allow the air core coil 1 to be automatically mounted on the circuit board 50. More specifically, the winding portion 1a of the air core coil 1 accommodated in the opening 51 of the circuit board 50 causes the first lead portion 1b and the second lead portion 1c to contact the surface of the circuit board 50 such that these lead portions rest on the circuit board 50. These lead portions thus prevent the air core coil 1 from falling through the circuit board 50 when releasing vacuum adsorption. Accordingly, the air core coil 1 may be automatically mounted on the circuit board 50 by an automatic mounter performing vacuum adsorption by the suction nozzle 200 (refer to FIG. 3). The mounting according to the embodiment of the present disclosure may lead to significant savings in time and in manpower compared with the mounting of the air core coil on the circuit board by human beings or by a special mounter dedicated for air core coils as in the related art.

Now, turning to the configuration in the related art shown in FIG. 11, the air core coil 2 has the first lead portion 2b and the second lead portion 2c extending toward the outer side of the winding portion 2a in the same direction and being substantially parallel to each other. For automatic mounting of the air core coil 2 having such a configuration on the circuit board 3 by vacuum adsorption, the first lead portion 2b and the second lead portion 2c of the air core coil 2 are preferably positioned vertically with respect to the surface of the circuit board 3 while being vacuum-adsorbed. To achieve such a posture of the air core coil 2, the air core coil 2 is preferably provided with a planarized portion adsorbed by the suction nozzle 200, or a flat-shaped material adhered thereto. However, these processes lead to an increase in the number of steps for manufacturing components and in manufacturing costs.

According to the embodiments described above, the air core coil 1 having the configuration described above allows the winding portion 1a to be mounted into the opening 51 of the circuit board 50, and thereby the number of manufacturing steps and manufacturing costs are reduced.

Moreover, the air core coil 1 mounted at the tuner section 100 according to the embodiments described above may serve as both an inductor provided at the HPF 110 attenuating unwanted out-of-band waves and an element preventing the device from being destroyed by a lightning-induced surge. Accordingly, the number of components may be reduced.

Furthermore, employing the air core coil 1 having a high Q factor as the inductor provided at the HPF 110 attenuating unwanted out-of-band waves may suppress attenuation of the input signals at the high-frequency circuit at a low level.

In the embodiments described above, the air core coil 1 is applied to, for example, the tuner section 100 of the television receiver, the air core coil being an element preventing a device from being destroyed by a lightning-induced surge. The application of the air core coil 1 is, however, not limited to this example. The air core coil may be applied to any electronic devices connected to a lead-in wire from outdoor and expected to be thinner. The air core coil may be applied to the electronic devices including modems, personal computers, telephones, and intercoms.

Additionally, the embodiments described above employ the air core coil 1 as, for example, the element preventing the device from being destroyed by a lightning-induced surge. The application of the air core coil 1 is, however, not limited to this example. The air core coil may be applied to inhibit a high frequency resonance and a high frequency.

Additionally, the present disclosure may also be configured as below.

(1) A circuit board including:

an air core coil including
a winding portion having a conductive wire wound in a helical shape,
a first lead portion extending from an end of the winding portion, and
a second lead portion extending from another end of the winding portion,
wherein the first lead portion and the second lead portion extend in different directions from each other on a substantially same plane; and

a coil mounting portion including
an opening to accommodate the winding portion,
a first conductive part provided on a periphery of the opening and contacting the first lead portion, and
a second conductive part provided on the periphery of the opening and contacting the second lead portion.
   (2) The circuit board according to (1),

wherein a length of long sides of the opening is equal to or longer than a length of a winding wire of the winding portion of the air core coil in a winding direction, and a length of short sides of the opening is longer than an outer diameter of the winding portion and shorter than a total length of the outer diameter of the winding portion, the first lead portion, and the second lead portion.

(3) The circuit board according to (1) or (2), the circuit board being mounted on an electronic device,

wherein one of the first lead portion and the second lead portion of the air core coil is connected to an input terminal through which an input signal coming from outside is input to the electronic device, and the other lead portion is grounded.

(4) The circuit board according to any of (1) to (3),

wherein the input terminal is an antenna input terminal

(5) The circuit board according to any of (1) to (4),

wherein the first lead portion and the second lead portion are bent at approximately 90 degrees in a direction parallel with the winding direction of the winding portion.

(6) The circuit board according to any of (1) to (4), wherein the first lead portion and the second lead portion are bent at approximately 90 degrees in a direction perpendicular to a surface of the coil mounting portion.
(7) A method for mounting an air core coil, including:

accommodating a winding portion of the air core coil in a coil mounting portion, the winding portion including a first lead portion extending from an end of the winding portion and a second lead portion extending from a another end of the winding portion, the first lead portion and the second lead portion extending in different directions from each other on a substantially same plane, and the coil mounting portion including an opening to accommodate the winding portion, a first conductive part provided on a periphery of the opening and contacting the first lead portion, and a second conductive part provided on the periphery of the opening and contacting the second lead portion; and

electrically connecting the first lead portion and the second lead portion to the first conductive part and the second conductive part, respectively.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-163244 filed in the Japan Patent Office on Jul. 26, 2011, the entire content of which is hereby incorporated by reference.

What is claimed is:

1. A circuit board comprising:
an air core coil including
a winding portion having a conductive wire wound in a helical shape,
a first lead portion extending from an end of the winding portion, and
a second lead portion extending from another end of the winding portion,
wherein the first lead portion and the second lead portion extend in different directions from each other on a substantially same plane; and
a coil mounting portion including
an opening to accommodate the winding portion,
a first conductive part provided on a periphery of the opening and contacting the first lead portion, and
a second conductive part provided on the periphery of the opening and contacting the second lead portion.

2. The circuit board according to claim 1,
wherein a length of long sides of the opening is equal to or longer than a length of a winding wire of the winding portion of the air core coil in a winding direction, and a length of short sides of the opening is longer than an outer diameter of the winding portion and shorter than a total length of the outer diameter of the winding portion, the first lead portion, and the second lead portion.

3. The circuit board according to claim 2, the circuit board being mounted on an electronic device,
wherein one of the first lead portion and the second lead portion of the air core coil is connected to an input terminal through which an input signal coming from outside is input to the electronic device, and the other lead portion is grounded.

4. The circuit board according to claim 3,
wherein the input terminal is an antenna input terminal.

5. The circuit board according to claim 2,
wherein the first lead portion and the second lead portion are bent at approximately 90 degrees in a direction parallel with the winding direction of the winding portion.

6. The circuit board according to claim 2,
wherein the first lead portion and the second lead portion are bent at approximately 90 degrees in a direction perpendicular to a surface of the coil mounting portion.

7. A method for mounting an air core coil, comprising:
accommodating a winding portion of the air core coil in a coil mounting portion, the winding portion including a first lead portion extending from an end of the winding portion and a second lead portion extending from a another end of the winding portion, the first lead portion and the second lead portion extending in different directions from each other on a substantially same plane, and the coil mounting portion including an opening to accommodate the winding portion, a first conductive part provided on a periphery of the opening and contacting the first lead portion, and a second conductive part provided on the periphery of the opening and contacting the second lead portion; and
electrically connecting the first lead portion and the second lead portion to the first conductive part and the second conductive part, respectively.
